(19) United States
(12) Patent Application Publication
(10) Pub. No.: US 2015/0088719 A1
(43) Pub. Date: Mar. 26, 2015

(54) Method for Predicting Financial Market Variability

(71) Applicant: UNIVERSITY OF WINDSOR, Windsor (CA)

(72) Inventors: Robin GRAS, Windsor (CA); Abbas GHADRIGOLESTANI, Windsor (CA)

(21) Appl. No.: 14/492,299

(22) Filed: Sep. 22, 2014

Related U.S. Application Data
(60) Provisional application No. 61/882,863, filed on Sep. 26, 2013.

(51) Int. Cl. G06Q 40/00

(52) U.S. Cl. CPC G06Q 40/00
USPC 705/35

(57) ABSTRACT

A system that is able to predict, model and monitor time lines of chaotic non-linier data or events such as commodity, stock and financial market performance indicators.

### RELATED APPLICATIONS

This application claims priority and the benefit pursuant to 35 U.S.C. §119(e) to U.S. Provisional Patent Application Ser. No. 61/882,863, filed 26 Sep. 2013.

### SCOPE OF THE INVENTION

The present invention relates to a method and system for performing predictive data modeling, and more particularly a system for achieving the predictive chaos analysis of non-linear data or events, such as stock and financial market performance. The system and method however, may further be applied to the prediction and/or analysis of other non-linear events, including environmental monitoring and/or pathogenic risk assessments and modelling.

### BACKGROUND OF THE INVENTION

Long-term time series prediction has promise for many applications, such as prediction of earthquakes, financial market prediction, and the like, and where non-linear properties of a time series are evaluated and used for long-term prediction.

The prediction of complex time series future values is therefore a major concern for scientists with applications in various fields of science. Many natural phenomena such as variations in population, the orbit of astronomical objects and earth's seismic waves could be subject to a prediction algorithm. Prediction also has application in forecasting economic time series. Prediction of other data such as population projections may be used to predict species extinction before they reach a tipping point may provide another application of time series prediction.

It has been shown that many data generated by such natural phenomena follow chaotic behavior. Various authors have proposed models for the predictive analysis of non-linear and chaotic events. Clements et al. in Forecasting Economic and Financial Time-Series with Non-linear Models, International Journal of Forecasting 20 (2004) 169-183 highlights the difficulties associated with conventional non-linear models used in the prediction of economic behavior and performance. Further, Yang et al. in Forecasting the Future: Is It Possible for Adiabatically Time-Varying Non-Linear Dynamical Systems? CHAOS 22, 033119 (2012) proposes a non-linear dynamical system in which parameters vary adiabatically with time where measured time series is used to predict future asymptotic attractors to the system.

Wang et al. in Fuzzy Prediction of Chaotic Time Series Based on Fuzzy Clustering, Asian Journal of Control Vol. 13, No. 4, pp 576-581 (2011) describe a process for time series prediction for use in weather forecasting, speech coding, noise cancellation and the like.

Most of the existing methods for complex time series prediction are based on modeling the time series to predict future values, although there are other types of methods like agent-based simulation that model the system generating the time series [Filippo Neri: Learning and Predicting Financial Time Series by Combining Natural Computation and Agent Simulation. Evo Applications (2) 2011: 111-119]. The model based approaches may be mainly classified in two main domains: linear models like ARIMA (AutoRegressive Integrated Moving Average) [G. Box and G. Jenkins, Time Series Analysis: Forecasting and Control, Holden-Day, San Francisco, 1976] and non-linear models like MLP [Zirilli, J.: Financial prediction using Neural Networks. International Thompson Computer Press (1997)] and GARCH [Bollerslev, Tim (1986). “Generalized Autoregressive Conditional Heteroskedasticity”, Journal of Econometrics, 31:307-327]. However, studies have concluded that there was no clear evidence in favor of non-linear over linear models in terms of forecast performance.

Although chaotic behaviors are deterministic, their complex properties make them hard to be distinguishing from random behavior. They are well known to be strongly dependent on initial conditions, small changes in initial conditions possibly leading to tremendous changes in subsequent time steps, and particularly difficult to predict. Since the exact conditions for many natural phenomena are not known and the properties of a chaotic time series are very complex, previously it is has proven difficult to model these systems.

Heretofore, however, there has been no robust procedure that can estimate an accurate model for chaotic time series. For conventional predictive methods, the prediction error increase dramatically with the number of time point predicted. As a result, most of existing methods focus on very short-term prediction to reach a reasonable level of accuracy. For example, for financial time series prediction a simple step ahead, may not prove overly helpful for acting against financial recession beforehand. Despite of the difficulties inherent to non-linear modeling, non-linear analysis has the potential for a variety of commercial applications.

### SUMMARY OF THE INVENTION

The present invention provides a method and system for generating predictive models, and more particularly for undertaking the predictive analysis of non-linear historical and/or real time data to predict the likelihood of a selected event or future trend. In the context of the present invention, the described herein method and system may be used in predicting long term variations across a variety of technologies, including without restriction, the prediction of medical events, economic and/or stock market trends and events; the prediction of seismological or meteorological events or outcomes; the prediction of ecosystem trends; the prediction of health, pandemic and/or demographic events; as well as other macrogeographic events.

The present invention seeks to provide a simplified process and system for predictive analysis, and more particularly which may provide improved reliability for chaotic or event prediction.

In one non-limiting embodiment, the invention provides a system and method for time series prediction which analyzes stock and financial market performance data over a period of time, and which is used to predict a likelihood of future performance trends and/or variability.

Most preferably, a baseline data recording period is selected whereby historical financial data is logged. The logged data is then broken into a number of data values across a series of individual set sampling periods, such as daily averages, or final values. The data values may be chosen as an individual data value at a selected sampling period, but more preferably are selected as discretized or averaged data values over a constant preselected period. In the case of financial or market trends, preferably the sampling periods are chosen as daily averages however longer or shorter periods may be used. A processor is operated to convert the collected data value readings for the individual sampling periods as a non-linear measure value for the recording period. Most preferably, the processor converts the data set over the selected recording period T_{sampleN} to a single value V(S_{N}) using a Lyapunov characteristic exponent to obtain a quantification of the rate of separation of events, and/or fractal deviation and/or Poincaré and Higuchi fractal dimension (P&H) to provide a statistical index of the complexity of the data over the selected set sampling period.

The present invention thus provides a simplified processes and systems for predictive analysis, and more particularly which may provide improved reliability for chaotic or event prediction.

In another non-limiting embodiment, the invention provides a system and method for time series prediction which analyzes historical financial or stock market data and operates to predict where in the future time series and financial trend and/or anomaly will occur, and which may later be confirmed by the future data.

In a preferred application, daily average financial data such as stock market pricing or index average are logged into; then transformed; and processed by a computer, PDA or other processing device continuously for a recording period ranging from several days, weeks, months, or longer. The data analysis window is and typically at least between about 30 to 180 days. Final selection of the data processing window is chosen based on data characteristics and the objective of the prediction. The level of confidence in the predicted data decreases as the predicted data window gets larger, and also with data that is predicted into the future beyond the time interval of the processing window.

Most preferably, the recording period is continued through uninterrupted after the baseline data has been recorded, allowing the system to continually update and output predictive data. The system may further operate to output to a user a display or warning signal, days or even weeks prior to the time a stock market correction, or period volatility is anticipated.

In another aspect the present invention resides in a predictive modelling system having a signalling mechanism for providing a user with advance warning where one or more predicted values or events exceed or falls within a predetermined threshold. By way of example, such a threshold may be set as a predicted percentage value change which differs from an average or present value by a selected amount. The system may further comprising: a processor or other computing device having a processor and memory, for receiving the historical data, the processor including program instructions operable to:

A. select and store in said memory said data values at a plurality of equally spaced time intervals over said monitored period as a first time series data sequence, and which preferably is used to initiate the system and establish constants to be used in future predicting data points;

B. compute an initial base-line non-linear measure V(S_{N}) value the initial time series of data points S_{N} using at least one of fractal dimension, Lyapunov exponent and P&H;

C. store the initial non-linear measure value V(S_{N}) as a reference value, D. determine a normal distribution curve of the changes in “Y” value between sequential data point values in the first time series data sequence;

E. with the normal distribution curve centered on the data point value associated with the last time interval (x_{N}) of the time series data sequence, generate at least 5, and preferably 7 to 15 random data signal values (Y₁, Y₂ . . . Y_{N}) for a predicted next time interval (x_{N+1}), as separate generated extended time series sequences;

F. for each said generated extended time series sequence, compute an associated non-linear measure value using fractal dimension, Lyapunov exponent and/or P&H (V₁, V₂ . . . V_{N}); and

G. select the generated extended time series sequence (x_{N+i}) having the associated non-linear measure value (V₁, V₂ . . . V_{N}) closest to the reference value V(S_{N}) as a new time series data sequence x_{N+1}.

The system is most preferably operable to output by graphic display, alarm and/or a signal an indication of a future predicted value or warn of targeted events related thereto.

In a further aspect, the present invention resides in a method of using a predictive device and/or system for providing a user with advance warning of a future trend and/or condition or targeted event. The system comprises a computing device having a processor and memory for receiving data, and software for performing method steps comprising:

A. storing in said memory data values selected a plurality of equally spaced time intervals over a monitored or initial period, as an initial time series data sequence;

B. with said processor, computing an initial base-line non-linear measure value V(S_{N}) of the first time series data of a first sequence using a combination of at least one of fractal dimension, P&H method and Lyapunov exponent, and storing the initial non-linear measure value V(S_{N}) in said memory as a reference value;

C. calculating a normal distribution curve of the difference in Y values of sequential data points in the time series data sequence, and

D. with the normal distribution curve centered on the associated data value of a last time interval (x_{N+i}) of the time series data sequence, randomly generate a plurality of random number values inside the centered normal distribution curve (Y₁, Y₂ . . . Y_{N}) at a predicted next equally spaced time interval (x_{N+1}), as part of an associated generated extended time series sequences;

E. compute an associated non-linear measure value using a combination of at least one of fractal dimension, P&H method and Lyapunov exponent (V₁=V(S_{N+i} Y₁), V₂=V(S_{N+i}+Y₂) . . . Vᵣ==V(S_{N+i}+Y_{N})) for each generated random number extended time series sequence;

F. select the generated random number value who's extended time series sequence having the associated non-linear V value is the closest to the reference value V(S_{N}) as a new time series data sequence S_{N+i+1}; and

if the data value in the predicted time interval of the new time series data sequence has three consecutive values that exceed the predetermined threshold value initiate output by graphic display or other visual and/or available signalling mechanism a signal to the user indicative of the predicted future value or an even connected thereto.

With the current system, the forward prediction limit is preferably chosen as a third of the time period of historical data N/3.

In accordance with another non-limiting aspect, the processor may be operable or further include program instructions to change base line reading interval; data source; data sampling interval; algorithm used to set V values; number of random numbers generated for predicting new values; restart system; and the like.

In addition, non-limiting aspect, the invention resides in:

a system and/or method in accordance with any of the aforementioned aspects wherein the fixed data sampling interval is consistent and is selected based on data being used and desired prediction period into the future. This may range between minutes to days, or even monthly or yearly periods.

(ii) A device, system and/or method in accordance with any of the aforementioned aspects wherein the base data set from which to make predictions of future data points is one third the base line data or less.

(iii) A device, system and/or method in accordance with any of the aforementioned aspects wherein the plurality of random data values used to predict the next data point is preferably greater than 4 and more preferably about or greater than 10.

(iv) A system and/or method in accordance with any of the aforementioned aspects further including a random number generator for generating the random data values in the value range calculated for the data centered on the value of the last point in the series.

(v) A device, system and/or method in accordance with any of the aforementioned aspects wherein said output signals comprise market values or readings over a plurality of constant time intervals, and the initial time period is selected as a time period consisting of several weeks or months to years.

(vi) A system and/or method in accordance with any of the aforementioned aspects wherein the computing device comprises a computer or personal digital assistant, and said signal mechanism comprises at least one of a graphic visual display and an audio output, and wherein the output signal comprises at least one of an audible signal emitted by said audio output and a visual signal visible on said visual display.

### BRIEF DESCRIPTION OF THE DRAWINGS

Reference may be had with the following detailed description, taken together with the accompanying drawings, in which:

FIG. 1 shows schematically a system for predicting and outputting to a user predictive values of future stock market trends in accordance with a preferred embodiment of the invention;

FIG. 2 illustrates graphically the step of generating predicted next time data values used to effect timed series prediction to generate future predicted stock market values;

FIGS. 3 to 5 illustrate graphically a comparison of a predictive model using the present invention, compared to conventional models in the analysis of historical Dow-Jones™ Industrial Average in accordance with alternate preferred embodiment of the invention.

### DETAILED DESCRIPTION OF THE PREFERRED EMBODIMENTS

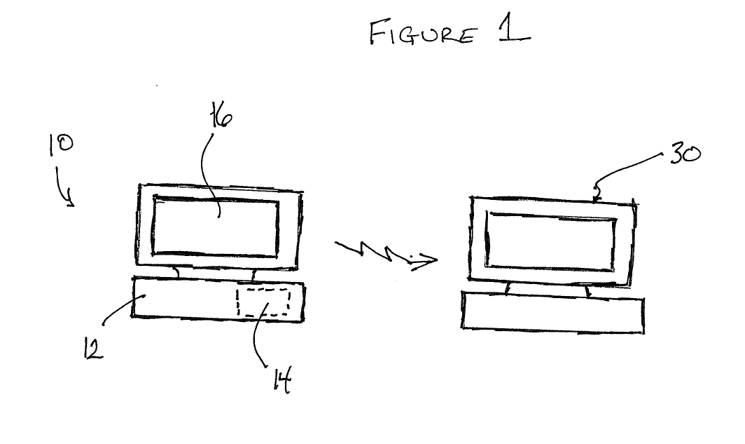

The present invention provides a system 10 and its method of operating for predicting the likely occurrence of a chaotic future or trend, and in a preferred embodiment, future stock indices values and trends. The system 10 is shown best in FIG. 1 as including a comprise processor 12, memory 20 and a video output 24.

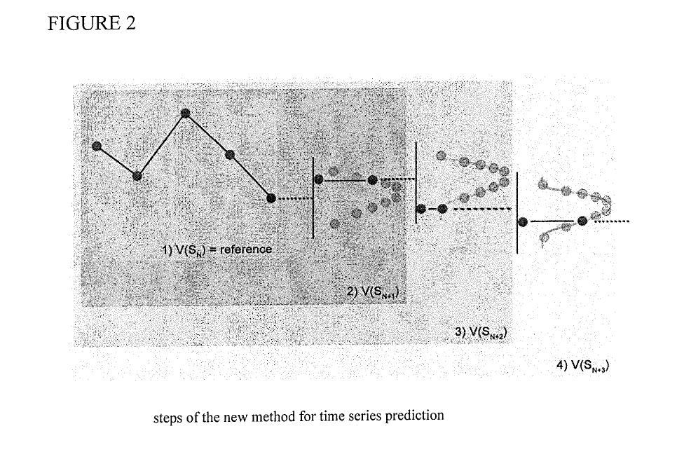

In a preferred mode of operation, a baseline set of historical data is collected over a preset initial sampling or monitoring period or time series Tₛₐₘₚₗₑ, where it is stored in memory. Preferably, the data is collected as a substantially continuous data file for an initial or baseline monitored period of time, at least several months and preferably one year or more as for example is shown graphically in FIG. 2. The monitoring period may be chosen as a measured time period selected most preferably where normal market conditions are in place and correction or stock mark collapse has not occurred.

The initial data is input and stored in the computer memory 20. The processor 12 is used to discretize data into a series of data values taken at equally spaced time intervals. In a most preferred embodiment, the processor operates to discretize the input values as average daily market indices values over the sampled time series. The stored data is used to generate an initial time series data sequence S_{N}, whereby data values are determined at each selected daily time intervals (x₁, x₂, . . . x_{N}), over a baseline monitored time interval. Thus as shown FIG. 2:

1. The smallest time interval taken in the illustrated time series is the sampling time between sequential data points such as x₁ and x₂; and the horizontal distance/time between points is always equal.

2. In the data time series may be expressed graphically, with the first sample point on the left is x₁, with the final point or time interval on the right is x_{N}, with the separation of each point increasing by 1 moving to x_{N}; the sequence of points (x₁, x₂, . . . x_{N}) in the initial measured time series data sequence may thus be expressed as S_{N} or S_{N}=(x₁, x₂, . . . x_{N}).

Following the establishment of the initial measured time series data sequence S_{N}=(x₁, x₂ . . . x_{N}), a non-linear measure value is determined for the measured time series data sequence as a reference value. Preferably, a computer or processor 12 is used to calculate the non-linear reference value for the series S_{N} a value V(S_{N}) calculated using one or more of “Fractal Dimension”, “Lyapunov” and/or “P&H”. This value is then represented by V(S_{N}).

The non-linear measure V(S_{N}) is thus computed on the time series S_{N}=(x₁, x₂ . . . x_{N}). The fractal dimension, the P&H value and the Lyapunov exponent are examples of preferred non-linear measures that return a single value for a time series.

Based on the historical data collected during the initial monitoring period Tₛₐₘₚₗₑ, the processor 20 is operable to generate randomly a series of possible next values at a next subsequent time interval (N+1). A non-linear time series is then generated for time series through the generation of 4 or more random number value values within a normal distribution of the Y values of the base data centered on the last data point in the time series. For each of the random number values a V value is determined using one or more of “Fractal Dimension”, “Lyapunov” and/or “P&H” and these values may then be compared against the value V(S_{N}) to identify the predicted next value x_{N+1} to be selected. In a simplified embodiment, the system 10 may output to a user an alert signal or display on the video output 24, or other identifier if three consecutive predicted future values deviate from a preselected threshold value by a preselected amount. Output warning signals may vary depending upon the resultant value which is predicted.

In a preferred operating mode, following the determination of the reference non-linear measure value V(S_{N}) of the initial time series data (S_{N}), a normal distribution curve is calculated for the current time series data sequence, which is stored in memory 20.

The processor 12 operates to generate and output a number of predicted future data values for the next time interval (x_{N+1}) at point in time in the future, and preferably up to one third of the time covered by the measured historical data points.

A most preferred method for long-term time series prediction is shown graphically in FIG. 2. Using the normal distribution calculated for the initial time series sequence described above, the distribution curve centered on the next predicted data point x_{N+i} x_{N+i} 1≦i≦K value of the last time interval T_{N+i} of the time series data sequence.

In particular, a parameter σ of the normal distribution N(xᵢ, σ²) 1≦i≦K of the data values is computed by computing the variation between every two consequent values (i.e. xᵢ to xᵢ₊₁). This distribution represents the distribution of probability of value of xᵢ, knowing xᵢ₋₁ (FIG. 1).

Next, the processor 12 is used to generate random number values, which is preferably at least five, and preferably ten or more new random values by a random number generator program for the next time interval (x_{N+i+1}) to be evaluated at the next point to be predicted for time (x_{N+i+1}). For predicting x_{N+i+1} Pos(x_{N+i+1}), the set of r random values are generated following the distribution N(x_{N+i}, σ²) (FIG. 2). Therefore where random r numbers are generated:

Pos(x_{N+i+1})={x_{N+i+1}, 1≦j≦r}

The number of random numbers generated is a parameter that can impact on the quality of the prediction, since having more values will increase the chance of finding an optimal value. However, it has been noted that significant improvement was not observed for the data considered when r was greater than ten.

For each of the random data values generated, y₁, y₂ . . . y_{N} an associated extended generated time series is created (S_{N+i+i}=(x₁, x₂, x₃, . . . , x_{N}, x_{N+1}, x_{N+i+1}). The extended generated time series sequence in then used to compute an associated non-linear measure value V(S_{N+i+1}) using fractal dimension, P&H method and/or Lyapunov exponent. As such, for each of the new points generated by the random number generator a new “V” value is established using the data sequence (x₁, x₂ . . . x_{N}, x_{N+1}, x^{j}_{N+i+1}), where x^{j}_{N+i+1} is one of the r new points generated by the random number generator.

The generated time series sequence having the associated non-linear measure value (V₁, V₂, V₃ . . . V₁₀) closest to the reference value V(S_{N}) is then chosen as the predicted next time series data point in the sequence S_{N+i+1}=x₂, x₃ . . . x_{N+i}, x_{N+i+1}). Further, the random number data value for the selected next time series data point in the sequence is assigned as the predicted data value for the next time interval T_{N+i+1}. x_{N+i+1} is thus computed by:

jₘᵢₙ=argminⱼ(|V(S_{N+i}+x^{j}_{N+i+1})−V(S_{N})|) with (S_{N+i}+x^{j}_{N+i+1}={x₁, x₂, . . . , x_{N+i}, x^{j}_{N+i+1}})x_{N+i+1}=x^{jmin}_{N+i+1}

The value x^{j}_{N+i+1} is chosen to make V(S_{N+i}+x^{j}_{N+i+1}) as close as possible to V(S_{N}).

The processor 12 preferably operates to effect the generation of subsequent future predicted values one time step at a time, where x_{N+1} is reclassified as the new last data value for the final time interval x_{N}; and the predicted next time series sequence is stored in the memory 20 as the new current time series data sequence S_{N}. The computer processor 12 then repeats the process of calculating the normal distribution, generating random data values and selecting generated time sequence for each successive new extended time series sequence. The predicted value in a current step is used for determining the valid range of change for each next step (FIG. 2). In the current method, several points are considered, and then by using non-linear measure, the more inaccurate points are diminished.

Technically, any non-linear measure could be used for the time series characterization. However, in one possible method, the P&H method [A. Golestani, M. R. Jahed Motlagh, K. Ahmadian, A. H. Omidvarnia, and N. Mozayani, “A new criterion for distinguish stochastic and deterministic time series with the Poincaré section and fractal dimension,” Chaos 19, 013137, 2009, this disclosure of which is incorporated herein by reference] may be selected as an alternative and/or in addition to Lyapunov weighing and/or fractal dimension, as it has been shown that this method can efficiently discriminate different types of non-linear behavior.

In a preferred use, the processor 12 is thus operable to output for a predetermined future period, a predicted future data values. Optionally outputs may be transmitted electronically to one or more remote server of a computer workstation 30 for display Further, where the predicted future data values exceed the preselected threshold value with three consecutive points which is chosen as representing a likely preselected event, the processor 12 may be used to output on the display 24 and/or remote workstations 30 a suitable visual warning or “display or” signal.

### Test Data

In preliminary testing, past stock market performance was monitored. In particular, market was discretized as a time series vector, X={x₁, x₂, . . . , x_{N}} comprised of single daily average readings, expressed as a series of individuals data points single DJIA (Daily Dow Jones Industrial Average readings by date), where N is the total number of data points and the subscript indicates the date or instant.

It is to be appreciated that establishing “V” values using “Fractal Dimension”, Lyapunov” and/or “P&H” are based on what is more appropriate for the application. It may also be acceptable to calculate “V” values using a combination of values of two or more such methods (“Fractal Dimension”, “Lyapunov” or “P&H”).

Using the P&H threshold value, the current method was shown to predict future stock market values with a high degree of sensitivity and specificity.

While it is not anticipated that the current method will provide 100% accuracy and specificity in all instances, preliminary testing has, however, suggested that the system and method of the present invention shows strong promise in providing a good indicator of likely future events.

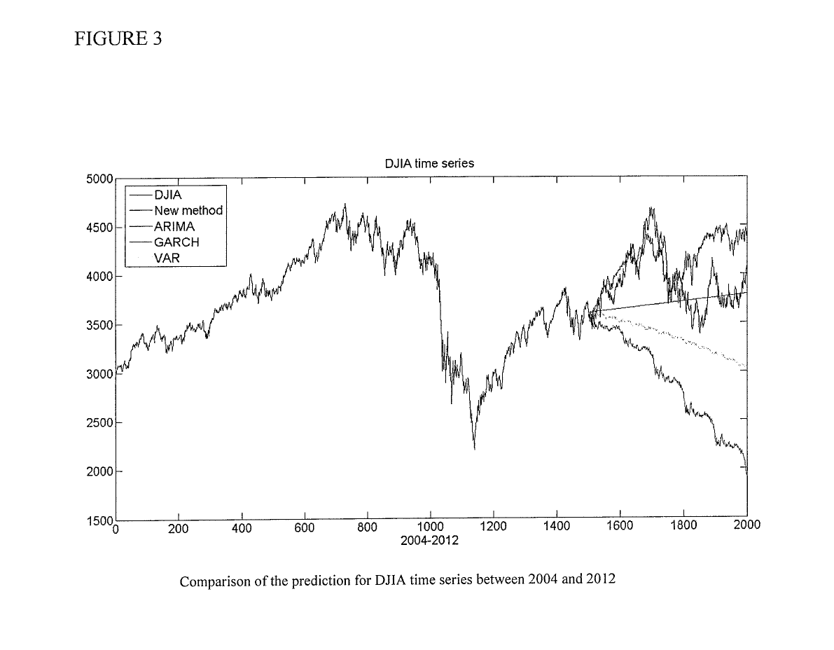

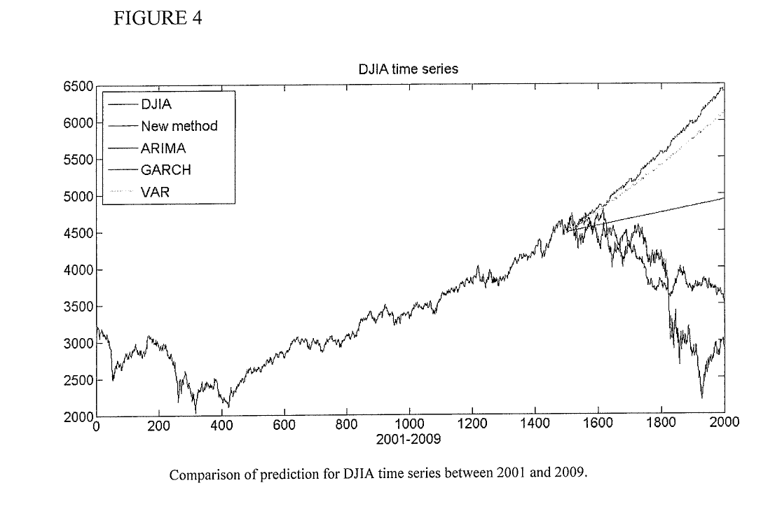

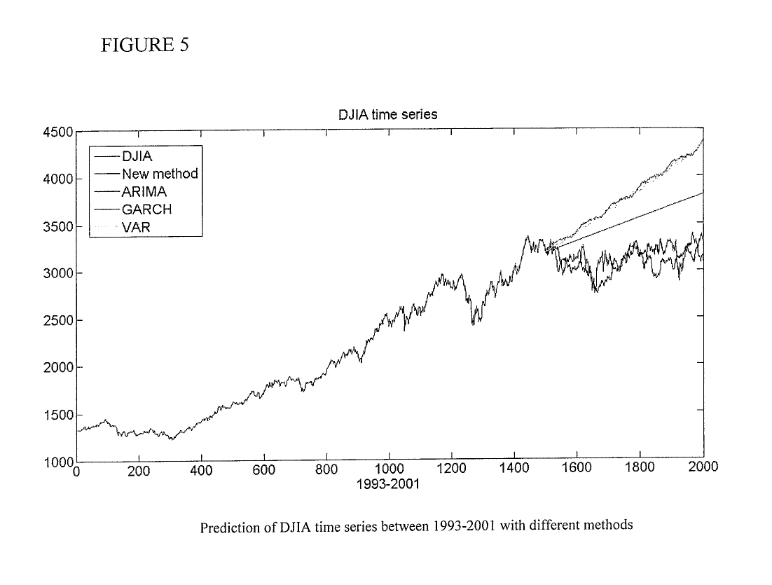

The current system and method shows promise for a wide variety of different applications. In particular, the method of the present invention shows promise in predicting a future stock index average, stock price or other sampled transactional variable. To evaluate the operability of the method described above in the analysis and prediction of other non-linear data, three financial time series were analyzed using both the current and conventional predictive measures (FIGS. 3 to 5). The DJIA time series was examined with respect to the daily closing values of the DJIA for three time periods: (A) September 1993-September 2001 for the prediction of DJIA values before the 2009 financial crisis, (B) July 2001-July 2009 for the prediction of the financial crisis in 2009 and (C) August 2004-August 2012 for the prediction of DJIA values after the financial crisis in 2009. For each time series, 1500 time steps (approximately 6 years) were analysed to predict the next 500 time steps (approximately 2 years). For each, 1500 time steps were considered for analysis to predict the next 500 time steps: using the Dow-Jones™ Industrial index (DJIA) time series. In particular, the daily closing values of the Dow Jones Industrial Average (DJIA) were examined over three periods of time August 2004-August 2012 (FIG. 3); July 2001-July 2009 (FIG. 4); September 1993-September 2001 (FIG. 5).

In the first selected period, the economic recession is reflected in the middle of range to see how the occurrence of the financial crisis in the middle range affects the prediction of market index. In the second selected period, the performance of new method on the prediction of financial crisis itself is analyzed. With the third selected period, (FIG. 3) the method is used to provide predictive values when markets are stable, and there was no big change or financial crisis.

A comparison of the accuracy of the predictive values obtained by the present method, with three conventional methods (ARIMA, GARCH and VAR) for short and long-term prediction is shown in Table 1 below. For one step prediction of the DJIA 1993-2001, the results obtained with the present method were compared with Learning Financial Agent Based Simulator (L-FABS) [Zirilli, J.: Financial Prediction Using Neural Networks. International Thompson Computer Press (1997)] and MLP model [Filippo Neri: Learning and Predicting Financial Time Series by Combining Natural Computation and Agent Simulation. Evo Applications (2) 2011: 111-119] which have shown good accuracy.

In the Dow-Jones Industrial index (DJIA) time series, in the first period (August 2004-August 2012), the recession is reflected in the middle of the considered range. The present method shows good prediction accuracy (4% errors in average) (Table 1). The ARIMA method performance for the same data achieves better accuracy than GARCH and VAR, but achieved lower accuracy than the present method (12% error in average). Even with the 2009 financial crisis data for validation, the present method successfully predicted the general trends for the next 500 steps, with particularly good accuracy for the first 300 steps, effectively predicting the increase in stock market (FIG. 2). Each of the three conventional predictive methods failed to predict the trend.

TABLE 1
Comparison of mean absolute percentage error (MAPE) [33] between several
methods and the new method for the prediction of DJIA time series.

| | | | | | | | | | Mean | Std |
|---|---|---|---|---|---|---|---|---|---|---|
| | 1 | 10 | 50 | 100 | 200 | 300 | 400 | 500 | (1-500) | (1-500) |
| DJIA 2004-2012 | | | | | | | | | | |
| ARIMA | 0.93% | 3.5% | 7% | 12% | 17% | 8% | 19% | 17% | 12% | 5% |
| GARCH | 0.65% | 2% | 12% | 19% | 37% | 44% | 95% | 125% | 47% | 32% |
| VAR | 0.93% | 3% | 9% | 16% | 26% | 20% | 40% | 46% | 24% | 12% |
| New method | 0.43% | 1.5% | 0.3% | 2% | 4% | 3% | 13% | 8% | 7% | 4% |
| DJIA 2001-2009 | | | | | | | | | | |
| ARIMA | 0.15% | 2.5% | 3% | 4% | 7% | 13% | 41% | 40% | 19% | 17% |
| GARCH | 0.02% | 1.5% | 6% | 9% | 17% | 25% | 52% | 54% | 27% | 20% |
| VAR | 0.02% | 2% | 5% | 8% | 14% | 23% | 50% | 52% | 26% | 19% |
| New method | 0.03% | 0.8% | 1.5% | 3% | 0.27% | 7% | 24% | 15% | 10% | 8% |
| DJIA 1993-2001 | | | | | | | | | | |
| ARIMA | 0.22% | 0.5% | 4% | 5% | 10% | 11% | 10% | 18% | 10% | 5% |
| GARCH | 0.22% | 0.7% | 6% | 8% | 15% | 18% | 20% | 28% | 16% | 7% |
| VAR | 0.25% | 0.46% | 5% | 7% | 15% | 17% | 19% | 28% | 15% | 7% |
| New method | 0.14% | 0.23% | 1% | 3% | 3% | 0.1% | 3% | 2% | 3% | 2% |
| L-FABS | 0.57% | — | — | — | — | — | — | — | — | — |
| MLP | 1.06% | — | — | — | — | — | — | — | — | — |

In the second considered period (FIG. 4), the US stock market peaked in October 2007. By March 2009, the Dow Jones average had fallen to its minimum level reflecting worst affect of 2008-2009 financial crisis. The prediction data for the 300 first steps using the present method remained with acceptable tolerances (less than 3% error); whereas accuracy decreased significantly for the last 200 steps at the maximum peak of the financial crisis (Table 1). FIG. 4 shows the ARIMA as still better than the GARCH and VAR approaches, however, its performance was significantly lower than the current method for the 500 steps. Moreover, the present method was the only one operable to predict the decreasing trend corresponding to the financial crisis. Each of the three conventional methods predicted a growth in the stock market, during the corresponding period.

The third analysis was undertaken for the DJIA time series between 1993 and 2001 (FIG. 5). This data is simpler to predict than the two previous ones, and the resulting prediction accuracy is ignored. However, the method of the present invention still was shown to clearly outperform the three convention methods (Table 1) with an overall error rate of 2%.

The current method is thus operable to predict trends with improved accuracy, whereas conventional methods of predictions were shown to strongly and rapidly diverge from the real data. The method of the current invention was further shown to also outperform both F-FABS and MLP method, and which are dedicated to short term prediction, for the first step prediction on this data.

In another possible non-limiting embodiment, the system 10 may be used to establish predictive health events or environmental models. In one embodiment, data representing past measured amounts of vegetative growth of a particular plant or algae may be input for a selected historical time period. Using the foregoing method, the processor may provide output data which is predictive of when a selected plant species may dominate or be subordinated relative to other species within a particular geographic area.

In accordance with another preferred mode of operation, a selected number of data points N of the non-linear variable are monitored over a selected time sampling period T(N), numbering roughly in range of 1000 to 2500, and preferably about 1500. Where the system is used in predicting stock events, the monitoring period is preferably selected at least about 20 days, with individual sampling time intervals of as little as hourly or more preferably selected at daily intervals. In such embodiments the processor 12 is operable whereby:
a. Using the data points one or more of, “Fractal dimension” (P&H) and “Lyapunov exponent” calculation is used to achieve a single constant that characterizes a non-linear data reference value of a fixed interval time series V(S_{N}) for the monitored period.
b. The standard deviation (sd) for the absolute value of the change in “Y” value between data points (x₁ to x₂, x₂ to x₃, x₃ to x₄, . . . x_{N}) over the monitored period is determined.
c. To determine the predicted data value of a next future time interval, a normal distribution curve N is defined based on the standard deviation (sd), and the curve is then centered on the data value determined at the last time interval of the time series.
d. Preferably at least 10 or more random data points are generated (by a random number generator biased to curve N) following the normal distribution curve N. For each random number data point generated an associated non-linear V data value is calculated. (V₁, V₂ . . . V_{N})
e. Each of the new non-linear data V values (V₁, V₂ . . . V_{N}) are compared with the originally calculated V(S_{N}) reference value, and the random number value having a V value that is the closest corresponding to the V(S_{N}) value is selected, with its associated random number value chosen as the prediction for the next predicted time interval value in the time sequence.
f. Using the generated time series sequence, the next subsequent predicted data value is determined by repeating steps d. to e. above. The process calculations may continue to be used to generate new predicted data values or points. Most preferably, number of new data points created in the sequence does not exceed one third of the total number of historic data points (N/3) used to achieve the constant V(S_{N}) in step a. above.
g. To create a next predicted data point from the last data point generated, go back one (or optionally N) data point and set that data point as xᵢ. Using the set data point xᵢ as the new first data point, the calculation is then restarted for the rapid generation of new data.

As a result, with the present method historical data may be rapidly updated. Instead of making a shift of N data points at a time, a shift of a single data point is undertaken. That means that just one new real point value is measured (N+1) and then the new historical data to be taken into account are (2, 3, . . . , N+1), and the new prediction begin at N+2.

In the preferred mode, the reference value V(S_{N}) is maintained, and which is obtained based on the value of the non-linear measure from the original time series. Therefore, according to the present method:
1. It is advantageous to keep the value of a non-linear measure steady as much as possible during prediction (see FIG. 2).
2. The new value is chosen from a set of potential values generated from a distribution of probability in an acceptable selection range.

With the current system, prediction is performed using the complete time series whereas, in traditional approaches, after computation of the model, prediction is performed only using the model and no longer the original time series. Therefore, the current model allows for constant adjustment of information about the current time series, whereas classical predictive methods apply the model without taking into account the accordance between the original time series properties and the predicted ones. Moreover, the optimization step allows making choice among a set, a potentially good predictive values, compared to the traditional models which only generate one value. Another advantage of the present invention is that it does not rely on a complex model of the original time series and it is therefore very general. Having no specialized model for prediction makes new method less restricted to a specific domain.

The present method shows a strong improvement compared to traditional methods over different situations and other chaotic time series in term of accuracy both for short and long term prediction. Moreover, the present method shows ability to predict the trend of evolution of other chaotic time series is much better than those of existing methods. Its performances are also more stable, with a standard deviation of the error measure appearing lower than those of the other methods. The method provides step toward an accurate and comprehensive time series long-term prediction.

It should be noted that preferred embodiment of the present method is not customized for a specific application, however using a non-linear criterion may not have the same function for a variety of applications. Further, by involving knowledge from other fields, it may be possible to provide a universal method for predicting a variety of non-linear time series. In another embodiment, the present method could utilize several non-linear measures simultaneously, instead of using just one measure, to identify and preserve the complexity of time series more efficiently.

Although the preferred embodiment describes the system and process for use in the predictive analysis of economic, health and environmental events, the invention is not so limited. It is to be appreciated that the present process and system is equally applicable across a number of other possible applications. Such applications could include without restriction, applications in predicting macrogeographic events and trends; the predictive modeling of pandemics and pathogenic outbreaks; weather and meteorological modeling; and/or earthquake and geological event modeling.

Although the disclosure describes and illustrates various preferred embodiments, the invention is not so limited. Many modifications and variations will now occur to persons skilled in the art. For a definition of the invention, reference may be had to the appended claims.

We claim:

1. A system to monitor and predict likely future financial market trend and/or event, the system comprising:
a output mechanism operable to provide an output of at least one or more of: graphic display; data charts; an audible, alarm display; or sensory warning signal to said user indicative of a predicted trend or event;
a computing device having a processor and memory, the computing device electronically connected to: input device(s) to allow computer to receive data for processing; a signaling mechanism to effect the output of said display or signal,
said memory including baseline data representative of stock or indices performances over a monitored period of time,
the processor including program instructions operable to perform the process steps of:
A. generating a first time series data sequence comprising associated data values for the baseline data at a number of selectable equally spaced time intervals over said monitored period of time,
S_{N}={x₁, x₂ . . . x_{N}}
B. compute a first non-linear measure value V(S_{N}) of the first time series data sequence using one or more of fractal dimension, Lyapunov exponent and P&H, and store the first non-linear measure value as a reference non-linear measure value;
C. determine a normal distribution curve of the changes in “Y” values of sequential data points of the time series data sequence;
D. with said normal distribution curve centered on the associated data value of a last said time interval (x_{N}) of the time series data sequence, generate a plurality of random data values (Y₁, Y₂ . . . Y_{N}) for a predicted next time interval (x_{N+1}), as separate generated extended time series sequences;
E. for each said generated extended time series sequence, compute an associated non-linear measure value using at least one of ort combination of fractal dimension, Lyapunov exponent or P&H (V₁, V₂ . . . V₁₀);
F. select the generated extended time series sequence having the associated non-linear measure V value closest to the stored reference non-linear measure V value V(S_{N}) as a next time series data sequence, and wherein the random data value for the selected extended time series sequence is assigned as the data value for the predicted next time interval; and
G. output the associated data value of the predicted next time interval to the user.

2. The monitoring system as claimed in claim 1, wherein the processor further includes program instructions to:
repeat steps D through F for each selected extended time series data sequence.

3. The monitoring system as claimed in claim 2, wherein the processor is operable to compare the data value of at least two predicted next time intervals with a predetermined threshold, and wherein when the at least two predicted next time interval exceeds the predetermined threshold, the system being operable to activate said signal mechanism to output said warning signal to the user.

4. The monitoring system as claimed in claim 1, wherein the number of spaced time intervals is selected at at least between about 180 and 730, and preferably more than 180.

5. The monitoring system as claimed in claim 2, wherein the plurality of random data values is selected at between about 5 and 16, and more preferably 10 or more.

6. The monitoring system as claimed in claim 5, further including a random number generator for generating the random data values with predetermined range of values.

7. The system as claimed in claim 2, wherein the computing device comprises a personal digital assistant, and said signal mechanism comprises at least one of a visual graphic display, readable data values, and an audio output, and wherein the output warning signal comprises at least one of an audible signal emitted by said audio output and a visual signal visible on said visual display.

8. A stock or financial market monitoring system having a signal mechanism for providing to a user an output of a predicted targeted market event(s), the system further comprising:
a computing device having a processor and memory, the memory storing historical stock or financial market data over a preselect period of time,
A. generate from said market data a data series comprising data values at a plurality of equally spaced time intervals over said monitored period as a first time series data sequence;
B. compute an initial base-line non-linear measure value V(S_{N}) of the first time series data sequence using fractal dimension P&H and/or Lyapunov exponent;
C. store the initial non-linear measure value V(S_{N}) as a reference value,
D. determine a normal distribution curve of the change in “Y” value between adjacent data point values in the time series data sequence;
E. with the normal distribution curve centered on the last data value associated with the last time interval (x_{N}) of the time series data sequence, generate at least 10 random data values (Y₁, Y₂ . . . Y_{N}) for a predicted next time interval (x_{N+1}), as separate generated extended time series sequences;
F. for each said generated random number value in extended time series sequence, compute an associated non-linear V value using said fractal dimension, P&H and/or Lyapunov exponent (V₁, V₂ . . . V₁₀); and
G. select the generated random number to extended time series sequence having the associated non-linear V value that is closest to the reference value V(S_{N}) as a new time series data point in sequence; and
wherein when the data value of the predicted next time interval is stored in said memory as a subsequent time series data point sequence.

9. The monitoring system as claimed in claim 8, wherein the processor further includes program instructions to:
H. repeat steps E to G following the selection of each subsequent new time series data sequence.

10. The monitoring system as claimed in claim 9, wherein when the data values of at least three successive predicted next time intervals differs from a preselected value by a threshold amount, the system being operable on output by the signal device warning the user indicative of the likelihood of said targeted event.

11. The monitoring system as claimed in claim 8, wherein said data values comprise stock or indice average values and the number of spaced time intervals is selected at least about 180.

12. The monitoring system as claimed in claim 11, comprising a random number generator for generating the random data signal values.

13. The system as claimed in claim 12, wherein the preselected period of time is selected at between about 180 and 730 days.

14. The system as claimed in claim 13, wherein the computing device comprises a personal digital assistant (PDA) and said signal device mechanism comprising at least one of a PDA visual display and an audio output, and wherein the output signal comprises at least one or more of: graphic display of predicted data values; an audible signal emitted by said audio output and a visual signal visible on said visual display.

15. A method of using a targeted event monitoring system for providing a user with advance warning of said targeted event; a stock or financial market trend or anomaly system comprising:
a computing device having a processor and memory to store retrieve and manipulate data, the memory for storing stock or financial market performance data over a monitored period of time, said method comprising,
A. storing in said stock or financial market performance data as data values a plurality of equally spaced time intervals over said monitored period as an initial time series data sequence;
B. with said processor, computing an initial base-line non-linear measure value V(S_{N}) of the first time series data of a first sequence using at least one of fractal dimension, P&H and Lyapunov exponent, and storing the initial non-linear measure value V(Sᵢ) in said memory as a reference value;
C. calculating a normal distribution curve of the changes in “Y” value between sequential data points in the time series data sequence, and
D. with the normal distribution curve centered on the associated data value of a last time interval (x_{N}) of the time series data sequence, randomly generate a plurality of random data values (Y₁, Y₂ . . . Y_{N}) at a predicted next equally spaced time interval (x_{N+1}), as part of an associated generated extended time series sequences;
E. compute an associated non-linear measure V value using at least one of P&H fractal dimension, and Lyapunov exponent (V₁, V₂ . . . V₁₀) for each random number generated extended time series sequence;
F. select the random number generated to extended time series sequence having the associated non-linear V value closest to the reference V value V(S_{N}) as a new next point in the time series data sequence; wherein the data point value of the predicted next time interval is output to said user.
G. repeating steps E to G following the selection of a subsequent new time series data sequence and if the data value values of at least three successive predicted next time intervals differ from a preselected value by a threshold amount, output by the signal mechanism signal to the user indicative of the likelihood of said anomaly.

16. The method of using the monitoring system as claimed in claim 16, wherein the method further comprises:

17. The method of using the monitoring system as claimed in claim 16, wherein the monitored period of time is selected at between about 180 and 730 days.
